(19) United States
(12) Patent Application Publication
(10) Pub. No.: US 2011/0163863 A1
(43) Pub. Date: Jul. 7, 2011

(54) Driver's Alert System

(76) Inventor: Lonnie Chatmon, Dallas, TX (US)

(21) Appl. No.: 12/062,882

(22) Filed: Apr. 4, 2008

(51) Int. Cl. B60Q 1/00

(52) U.S. Cl. 340/439

(57) ABSTRACT

A device to aid an operator of a vehicle includes a steering wheel of the vehicle operable to steer the vehicle, a touchscreen mounted on the steering wheel of the vehicle, a detection system to detect the contact of the operator with the touchscreen, and an alarm to be activated in the absence of the contact of the operator and when the vehicle is moving. The alarm may be is an audible alarm or/and the alarm may be a visual alarm. The steering wheel is mounted on a steering column, and the alarm is mounted on the steering column. The touchscreen may be positioned within a circular area, and the touchscreen may be continuous around the steering wheel.

### BACKGROUND OF THE INVENTION

1. Technical Field

The present invention relates generally to an improved method for alerting a drowsy driver with the use of a touchscreen.

2. Description of the Related Art

Computer based devices utilizing touchscreen technology have become commonplace in many facets of life. Examples can include personal digital assistants (PDAs) such as the Palm Pilot, available from Palm Computing, Inc., of Santa Clara, Calif., and computer driven kiosks for dispensing information to shoppers and other consumers.

U.S. Pat. No. 7,190,348 discloses a method and system for use with a computer based system having a touchscreen for distinguishing between a finger and a stylus. The method involves a series of steps including detecting contact with the touchscreen. Also, the method can include generating contact information for the detected contact with the touchscreen. The method includes comparing contact information corresponding to the detected contact with contact criteria, and, based on the comparison of the contact information, determining whether the contact was initiated by a finger or a stylus.

A driver of a vehicle may become inattentive during driving due to fatigue or due to the monotony of operating a vehicle for an extended period of time. If a driver becomes inattentive or drowsy during vehicle operation, the likelihood of an accident increases, creating a hazard both to the driver and to surrounding vehicles.

Several methods have been utilized to detect if a vehicle operator is drowsy or unaware. Driver awareness has been monitored by a detector which measures the rate of eye blink or the frequency of brain alpha waves. A decrease in these rates indicates drowsiness or inattentiveness.

Additionally, the movement of the steering wheel or the movement of the driver can be monitored and measured to determine if a vehicle operator is unaware or drowsy. As a vehicle operates, the steering wheel is usually moved slightly, even if the vehicle is being operated on a straight path. The lack of any movement of the steering wheel can be an indicator of a drowsy driver.

After making the determination that a driver is drowsy or unaware, several prior methods have been utilized to alert and awaken the driver. The prior methods include utilizing sound to alert the driver. Noise is created by employing a tone or a buzzer, or by increasing the volume on an audio system.

Hence, there is a need in the art for an improved method for alerting a drowsy driver.

### SUMMARY

A device to aid an operator of a vehicle includes a steering wheel of the vehicle operable to steer the vehicle, a touchscreen mounted on the steering wheel of the vehicle, a detection system to detect the contact of the operator with the touchscreen, and an alarm to be activated in the absence of the contact of the operator and when the vehicle is moving.

The alarm may be is an audible alarm or/and the alarm may be a visual alarm.

The steering wheel is mounted on a steering column, and the alarm is mounted on the steering column.

The touchscreen may be positioned within a circular area, and the touchscreen may be continuous around the steering wheel.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates the back side of a steering wheel in accordance with the teachings of the present invention;

FIG. 2 illustrates the back side of the steering wheel in accordance with the teachings of the present invention;

FIG. 3 illustrates the system of the present invention;

FIG. 4 illustrates a flow chart of the present invention.

### DETAILED DESCRIPTION

The present invention employs a touchscreen system 300 to determine if the driver or a operator 104 of a vehicle is touching the steering wheel 100. FIG. 1 illustrates the back side of the steering wheel 100, and a portion of the steering wheel 100 includes a touchscreen area 210 in order to detect if the driver is touching the steering wheel 100. If the driver is not touching the touchscreen area 210, an audible alarm 110 is sounded and/or a visual alarm 108 flashes order to alert the driver of the situation. FIG. 1 illustrates that the touchscreen area 210 which includes a touchscreen forms a continuous circular area centered on the front surface of the steering wheel 100, but it is within the scope of the present invention that other shapes including noncontinuous portions form the touchscreen area 210. FIG. 1 additionally illustrates that the operator is touching the touchscreen at position 102.

FIG. 1 illustrates that the visual alarm 108 and the audible alarm 110 is mounted on the steering wheel column 112. However, the visual alarm 108 and the audible alarm 110 could be mounted on the steering wheel, on the dashboard, near the ceiling or any other position that is likely to be noticed by the driver or operator 104.

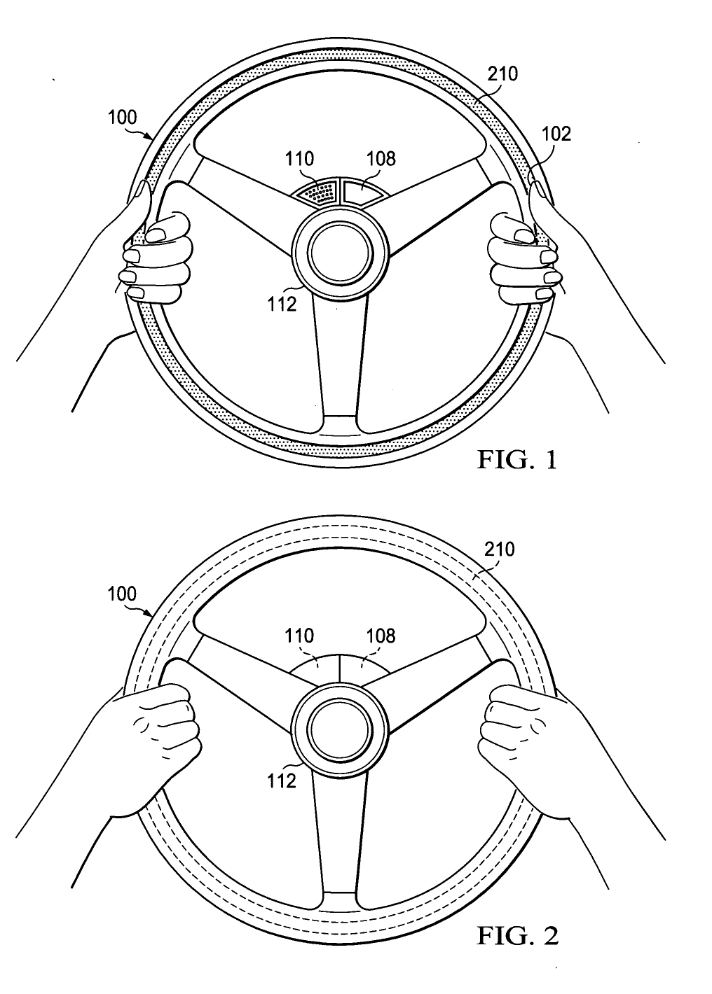

FIG. 2 illustrates the front side of the steering wheel 100 and illustrates the audible alarm 110 and the visual alarm 108 mounted on the steering column 112. The touchscreen area 102 is shown in phantom line, and the touchscreen is activated when the vehicle is moving.

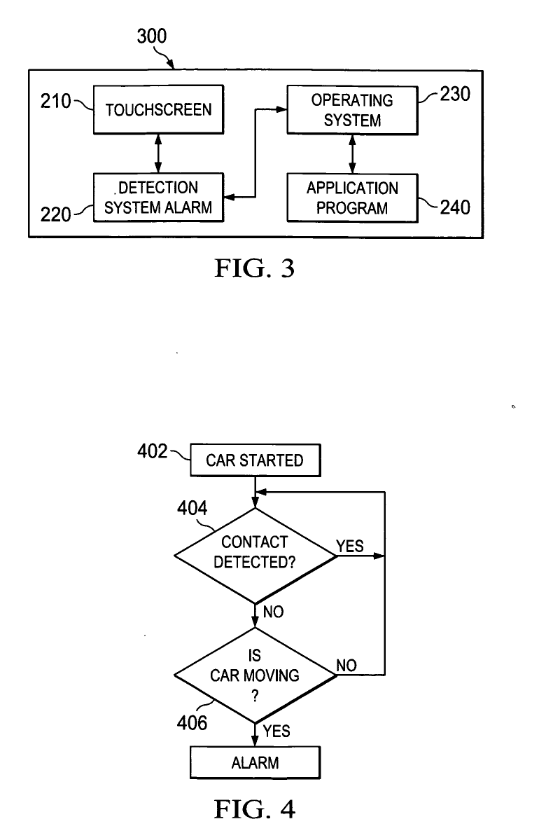

FIG. 3 illustrates a block diagram the system 300 in accordance with the teachings of the present invention. The touchscreen 210 is in communication with the detection system 220 which detects when the touchscreen 210 is touched by a operator 104 and which is in communication with the operating system 230. The operating system 230 directs the detection system 220 to activate either the visual alarm 108 or the audible alarm 110 or both the visual alarm 108 in the audible alarm 110.

FIG. 4 illustrates the operation of the present invention. The operating system 230 determines if the vehicle is started in step 402. If the vehicle is started, and if the detection system 220 determines if the operator has contact with the touchscreen area 102, the operating system 230 receives a communication from the detection system 220 on whether or not operator contact is made with the touchscreen area 102 in step 404. If contact is detected, then the operating system 230 continues to monitor the touchscreen area 102. If no contact is detected, then the operating system 230 determines if the car is moving or alternatively if the car is in gear in step 406. If the car is moving and the detection system 220 sounds the alarm which includes the visual alarm 108 and the audible alarm 110.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1) A device to aid an operator of a vehicle, comprising:
a steering wheel of the vehicle operable to steer the vehicle;
a touchscreen mounted on the steering wheel of the vehicle;
a detection system to detect the contact of the operator with the touchscreen,
an alarm to be activated in the absence of the contact of the operator and when the vehicle is moving.

2) A device to aid an operator of a vehicle as in claim 1, wherein the alarm is a audible alarm.

3) A device to aid an operator of a vehicle as in claim 1, wherein the alarm is a visual alarm.

4) A device to aid an operator of a vehicle as in claim 1, wherein the alarm is an audible alarm and a visual alarm.

5) A device to aid an operator of a vehicle as in claim 1, wherein the steering wheel is mounted on a steering column.

6) A device to aid an operator of a vehicle as in claim 5, wherein the alarm is mounted on the steering column.

7) A device to aid an operator of a vehicle as in claim 1, wherein the touchscreen is positioned within a circular area.

8) A device to aid an operator of a vehicle as in claim 1, wherein the touchscreen is continuous around the steering wheel.

9) A method for aiding an operator of a vehicle, comprising the steps of:
steering the vehicle;
detecting the contact of the operator with the touchscreen;
activating an alarm in the absence of the contact of the operator and when the vehicle is moving.

10) A method for aiding an operator of a vehicle as in claim 9, wherein the a audible alarm is activated.

11) A method for aiding an operator of a vehicle as in claim 9, wherein the a visual alarm is activated.

12) A method for aiding an operator of a vehicle as in claim 9, wherein an audible alarm and a visual alarm are activated.

13) A method for aiding an operator of a vehicle as in claim 9, wherein the steering wheel is mounted on a steering column.

14) A method for aiding an operator of a vehicle as in claim 13, wherein the alarm is mounted on the steering column.

15) A method for aiding an operator of a vehicle as in claim 9, wherein the touchscreen is positioned within a circular area.

16) A method for aiding an operator of a vehicle as in claim 9, wherein the touchscreen is continuous around the steering wheel.
